(19) United States
(12) Patent Application Publication
(10) Pub. No.: US 2018/0253435 A1
(43) Pub. Date: Sep. 6, 2018

(54) INFORMATION PROCESSING DEVICE, INFORMATION PROCESSING SYSTEM, AND COMPUTER PROGRAM PRODUCT

(71) Applicant: Kabushiki Kaisha Toshiba, Minato-ku (JP)

(72) Inventors: Hiroshi KAWAZOE, Kawasaki (JP); Daisuke AJITOMI, Setagaya (JP); Keisuke MINAMI, Kawasaki (JP)

(73) Assignee: Kabushiki Kaisha Toshiba, Minato-ku (JP)

(21) Appl. No.: 15/671,284

(22) Filed: Aug. 8, 2017

(30) Foreign Application Priority Data
Mar. 1, 2017 (JP) 2017-038573

(51) Int. Cl. G06F 17/30; G06F 3/06

(52) U.S. Cl. CPC G06F 17/30073; G06F 17/30353; G06F 3/0604; G06F 3/0683; G06F 3/0614

(57) ABSTRACT

An information processing device according to an embodiment includes a memory and one or more processors configured to function as a registration unit. The registration unit registers first information related to a statistical value of time series data in a second storage unit that is a volatile storage device or in a third storage unit that is a nonvolatile storage device in accordance with a registration frequency of the time series data in a first storage unit.

### CROSS-REFERENCE TO RELATED APPLICATIONS

This application is based upon and claims the benefit of priority from Japanese Patent Application No. 2017-038573, filed on Mar. 1, 2017; the entire contents of which are incorporate herein by reference.

### FIELD

Embodiments described herein relate generally to an information processing device, an information processing system, and a computer program product.

### BACKGROUND

A system to calculate and provide a statistical value from time series data is known. For example, received time series data is stored in a nonvolatile storage device. Furthermore, a system to acquire the time series data from the nonvolatile storage device, calculate a statistical value, and transmit the calculated value to an external device is known.

The nonvolatile storage device has higher reliability of stored data than a volatile storage device does. However, a data registration speed in the nonvolatile storage device and a data acquisition speed from the nonvolatile storage device are slower than those of the volatile storage device. Therefore, there may be a problem that the larger the number of populations of statistical values to be calculated is, the more increased a processing load is. On the other hand, a method of storing data in a volatile storage device is also known. In this case, a processing load can be reduced, but there may be a problem that the reliability of data cannot be guaranteed. In other words, in the related art, it may be difficult to achieve both suppression of degradation of data reliability and reduction of a processing load.

### BRIEF DESCRIPTION OF THE DRAWINGS

FIG. 1 is a schematic view of an information processing system;

FIG. 2 is a schematic diagram illustrating a configuration of the information processing device;

FIG. 3 is a diagram illustrating a data structure of time series data;

FIG. 4 is a diagram illustrating a data structure of first management information;

FIG. 5 is a diagram illustrating a data structure of third management information;

FIG. 6 is a diagram illustrating a data structure of second management information;

FIG. 7 is a diagram illustrating registration frequency;

FIG. 8 is a schematic diagram illustrating a flow of registration processing;

FIG. 9 is a schematic diagram illustrating a flow of the registration processing;

FIG. 10 is a diagram illustrating a data structure of an acquisition request;

FIG. 11 is a schematic diagram illustrating a flow of acquisition processing;

FIG. 12 is a schematic diagram illustrating a flow of the acquisition processing;

FIG. 13 is a sequence diagram illustrating a procedure of the registration processing;

FIG. 14 is a sequence diagram illustrating a procedure of the acquisition processing; and

FIG. 15 is a hardware configuration diagram.

### DETAILED DESCRIPTION

An information processing device according to an embodiment includes a memory and one or more processors configured to function as a registration unit. The registration unit registers first information related to a statistical value of time series data in a second storage unit that is a volatile storage device or in a third storage unit that is a nonvolatile storage device in accordance with a registration frequency of the time series data in a first storage unit.

An information processing device, an information processing system, and a computer program product will be described in detail below with reference to the attached drawings.

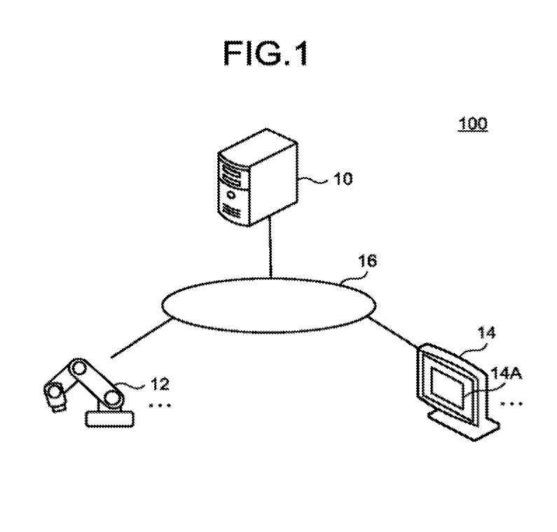

FIG. 1 is a schematic view illustrating an exemplary information processing system 100 according to the present embodiment.

The information processing system 100 includes an apparatus 12, a client device 14, and an information processing device 10. The information processing device 10, apparatus 12, and client device 14 are connected via a network 16 in a communicable manner. At least one of the information processing device 10, apparatus 12, and client device 14 is connected to the network 16 by wireless or wire.

Note that FIG. 1 illustrates a case where the information processing system 100 includes one apparatus 12 and one client device 14 in order to simplify the description. However, the information processing system 100 may also have a structure including a plurality of apparatuses 12. Additionally, the information processing system 100 may also have a structure including a plurality of client devices 14.

The apparatus 12 is a device to be managed by the information processing system 100. The apparatus 12 transmits, to the information processing device 10, time series data (described later in detail) used to calculate a statistical value.

The apparatus 12 may be any apparatus that can transmit time series data to the information processing device 10. Examples of the apparatus 12 include a home electric apparatus, a measuring apparatus, an apparatus to acquire information from an external device, a relay device to relay communication of apparatuses, and the like. Specifically, the apparatus 12 may include a device and a manufacturing device installed inside a manufacturing plant, a computer inside an information communication system or a broadcasting system, a communication device in the same system, an apparatus of a power plant and a power delivery system, a vehicle inside a transportation system of a transportation company such as a railway company, a management communication device inside a transportation system, a computer inside an on-line system, a communication device in the same system, a research apparatus, a physicochemical apparatus, an inspection device, a diagnostic device, a treatment device, a temperature measurement device, a power measurement device, a gateway apparatus, and the like.

The client device 14 transmits an acquisition request for a statistical value to the information processing device 10. Then, the client device 14 receives the statistical value in response to the acquisition request from the information processing device 10. The client device 14 is, for example, a personal computer (PC), a workstation, a server device, or the like. The client device 14 may also be a portable device or a fixed device. In the case of the portable device, the client device 14 is, for example, a tablet terminal, a communication terminal, a mobile terminal, or the like.

For example, a user application 14A is installed in the client device 14. The user application 14A is an application that operates on the client device 14. When acquisition of a statistical value is commanded in accordance with operation by a user at the user application 14A, the client device 14 transmits an acquisition request to the information processing device 10. Then, the information processing device 10 acquires the statistical value in response to the acquisition request from the client device 14.

Incidentally, there may be a case where the user application 14A does not have a user interface to receive a command from the user. In this case, for example, the client device 14 may function as a relay device to transmit an acquisition request acquired from another device to the information processing device 10. Also, the client device 14 may transmit, to another device, a statistical value acquired from the information processing device 10 or data obtained by applying arbitrary processing to the statistical value.

The information processing device 10 receives time series data from the apparatus 12. For example, the information processing device 10 discloses an HTTP API to the apparatus 12 and receives the time series data. Then, the information processing device 10 registers the time series data. Additionally, the information processing device 10 receives an acquisition request from the client device 14. For example, the information processing device 10 discloses the HTTP API to the user application 14A and receives the acquisition request. Then, the information processing device 10 calculates the statistical value from the time series data in response to the received acquisition request, and transmits the same to the client device 14.

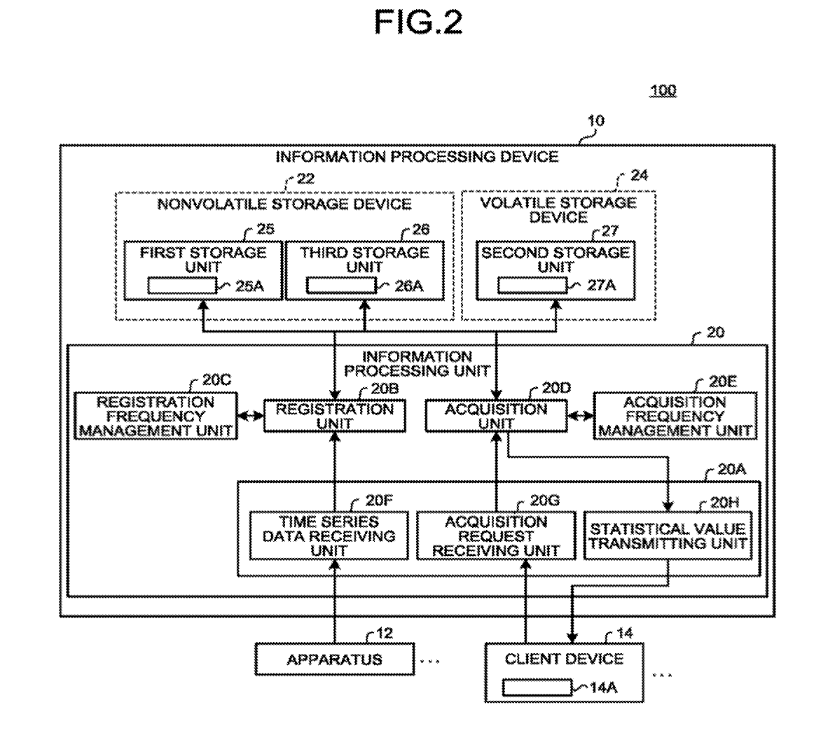

FIG. 2 is a schematic diagram illustrating an exemplary configuration of the information processing device 10.

The information processing device 10 includes an information processing unit 20, a nonvolatile storage device 22, and a volatile storage device 24. The information processing unit 20, nonvolatile storage device 22, and volatile storage device 24 are connected in manner capable of exchanging data and a signal.

The nonvolatile storage device 22 is at nonvolatile storage area. The nonvolatile storage device 22 is, for example, a read only memory (ROM), an electrically erasable programmable read-only memory (EEPROM), a flash memory (e.g., a solid stats drive (SSD)), a hard disk drive (HDD), or the like.

In the present embodiment, the information processing device 10 includes a first storage unit 25 and a third storage unit 26 as the nonvolatile storage devices 22.

Note that the first storage unit 25 and the third storage unit 26 may be configured as one nonvolatile storage device 22. Also, at least one of the first storage unit 25 and the third storage unit 26 may be mounted on an external device connected via the network 16.

The first storage unit 25 stores first management information 25A. The first management information 20A is a database to register time series data, received from the apparatus 12. Note that a data format, of the first management information 25A is not limited to the database.

The time series data includes an apparatus ID, a time stamp, and raw data.

The apparatus ID is identification information of the apparatus 12 that is a transmission source of the time series data. Note that the time series data may not necessarily include any apparatus ID. In the present embodiment, a description will be provided for an exemplary case where the time series data includes the apparatus ID.

The raw data is information indicating a state that irregularly changes with the elapse of time. The raw data is represented by, for example, a numerical value, note that the raw data may be represented by data other than a numerical value (such as a character or a symbol), or may also be mixture of the numerical value and data other than the numerical value. In the present embodiment, a description will be provided for an exemplary case where the raw data is numerical data.

For example, it is assumed that the apparatus 12 is a temperature measurement device or a power measurement device. In this case, the raw data is a measurement result of a temperature, a measurement result of power, or the like. Furthermore, it is assumed that the apparatus 12 is an in-house gateway apparatus of a home energy management system (HEMS). In this case, the raw data is, for example, a value of power consumption in an electric facility managed by the apparatus 12.

A time stamp indicates acquisition timing of the raw data. Note that the time stamp may also indicate generation timing or detection timing of the raw data.

In the present embodiment, the apparatus 12 acquires the raw data from a sensor, an external device, or the like, and regularly or irregularly transmits, to the information processing device 10, time series data including the acquired raw data, a time stamp indicating acquisition timing of the raw data, and the apparatus ID of the apparatus 12.

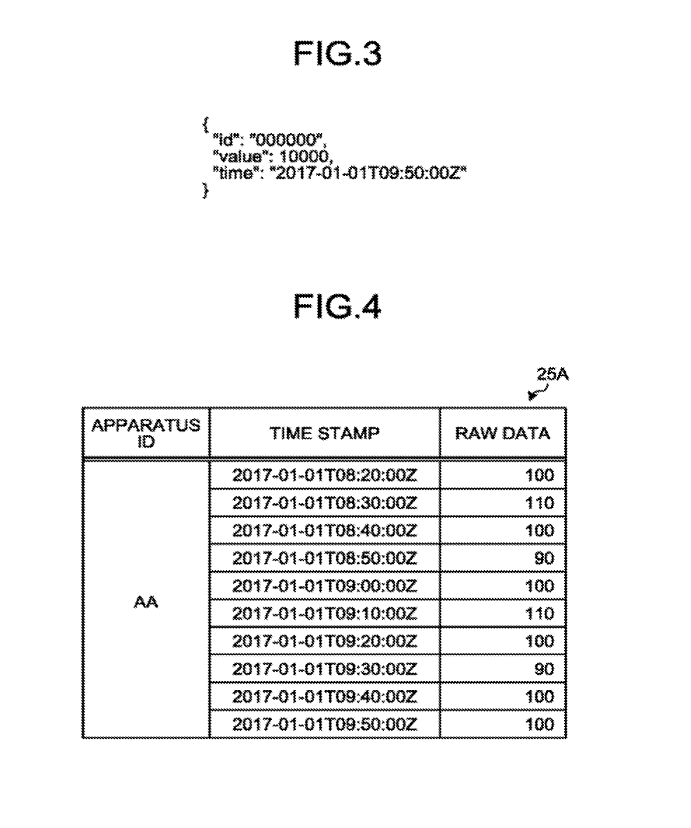

FIG. 3 is a diagram illustrating an exemplary data structure of time series data transmitted from the apparatus 12 to the information processing device 10. For example, the apparatus 12 generates an HTTP POST request and transmits the came to the information processing device 10. The HTTP POST request includes, in a payload (data body), the time series data having the data structure illustrated in FIG. 3, for example. In FIG. 3, “id” indicates the apparatus ID, “value” indicates the raw data, and “time” indicates the time stamp.

The information processing device 10 sequentially registers, in the first storage unit 25, time series data received from the apparatus 12. For example, the information processing device 10 sequentially registers the time series data in the first management information 25A of the first storage unit 25.

FIG. 4 illustrates an exemplary data structure of the first management information 25A. The first management information 25A is obtained by associating an apparatus ID, a time stamp, and raw data with one another. Upon acquisition of the time series data from the apparatus 12, the information processing unit 20 sequentially registers the acquired time series data in the first management information 25A of the first storage unit 25. Therefore, the time series data is sequentially registered in the first storage unit 25.

Returning to FIG. 2, the description will be continued. The third storage unit 26 stores third management information 26A. The third management information 26A is a database to register statistical values. Note that a data format of the third management information 26A is not limited to the database.

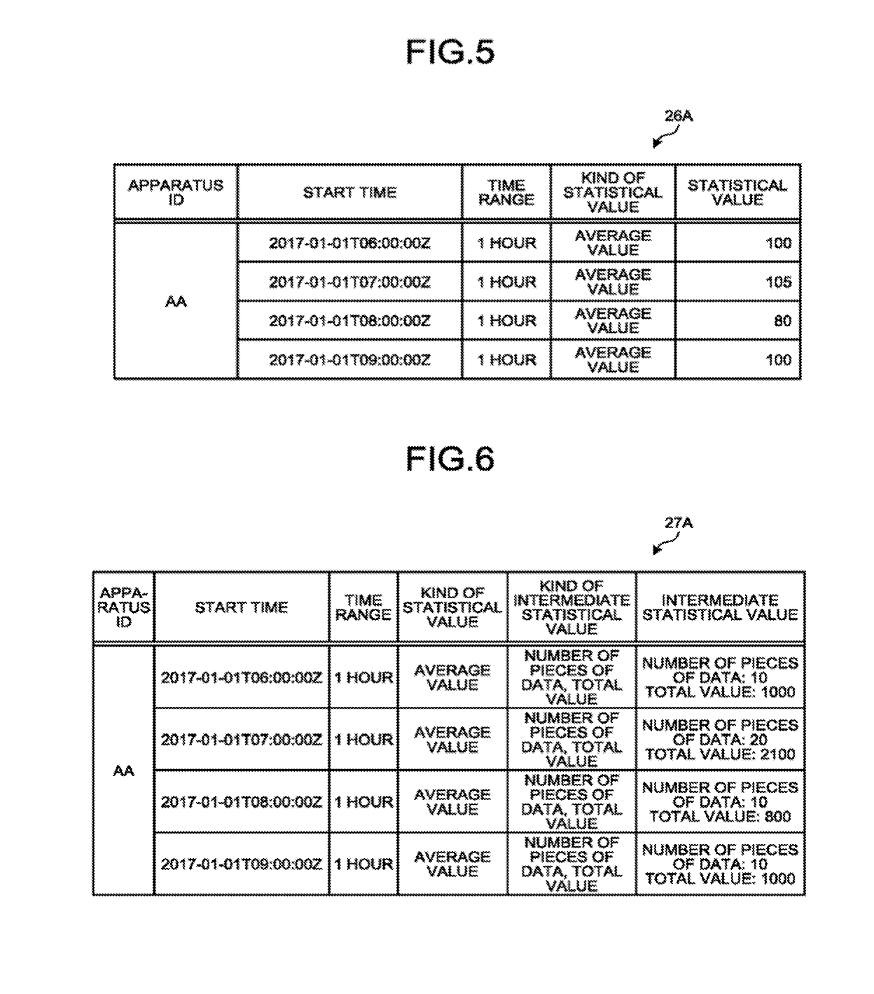

FIG. 5 is a schematic diagram illustrating an exemplary data structure of the third management information 26A. The third management information 26A is obtained by associating an apparatus ID, a start time, a time range, a kind of a statistical value, and a statistical value with one another. Note that the third management information 26A may not necessarily include the apparatus ID.

The statistical value is a value obtained by applying, to sample data (population of statistical values to be calculated), a statistical algorithm according to a purpose. In the present embodiment, the sample data is a set of raw data included in time series data. Exemplary statistical values include values in the time series data during a specific period, such as an average value of raw data, a total value of raw data, a maximum value of raw data, a minimum value of raw data, a variance value of raw data, number of pieces of raw data, sum of squares of raw data, a difference value of raw data, raw data of an oldest time stamp, and raw data of a latest time stamp. The difference value of raw data is a difference between the raw data of the oldest time stamp and the raw data of the latest time stamp within a corresponding time range.

A kind of a statistical value indicates a kind of a corresponding statistical value. Exemplary kinds of the statistical value include an average value of raw data, a total value of raw data, a maximum value of raw data, a minimum value of raw data, a variance value of raw data, number of pieces of raw data, sum of squares of raw data, a difference value of raw data, raw data of an oldest time stamp, raw data of a latest time stamp, and the like included in time series data.

The time range indicates a specific period used to calculate a corresponding statistical value. In other words, the time range is adapted to define a range of sample data to be used to calculate the corresponding statistical value. For example, the time range is a range for time stamps, such as one hour, one minute, one day, one week, one month, or the like. The start time indicates a first time stamp in the time range used to calculate a corresponding statistical value.

The third management information 26A is updated by the information processing unit 20 (described in detail later).

Returning to FIG. 2, the description will be continued. The volatile storage device 24 is, for example, a dynamic random access memory (DRAM), a static random access memory (SRAM), or the like.

In the present embodiment, a second storage unit 27 is used as the volatile storage device 24. The second storage unit 27 stores second management information 27A. The second management information 27A is a database to register first information. Note that a data format of the second management information 27A is not limited to the database. In addition, the second storage unit 27 may also be mounted on an external device connected via the network 16.

The first information is information related to a statistical value of the time series data. Specifically, the first information includes at least one of the time series data, a statistical value, and an intermediate statistical value.

The intermediate statistical value is data obtained by processing at least part of the raw data in order to derive the statistical value. Specifically, the intermediate statistical value is a value corresponding to each function term at the time of calculating the statistical value by using one or more functions for the raw data. Therefore, a load required in this processing in which the information processing unit 20 calculates the statistical value from the intermediate statistical value is smaller than that in processing in which the statistical value is calculated from raw data.

A kind of the intermediate statistical value is determined in accordance with a kind of the statistical value. For example, in the case where the kind of the statistical value is “average value” of the raw data, kinds of the intermediate statistical value are “number of pieces” and “total value” of the raw data. Additionally, for example, in the case where the kind of the statistical value is “variance value” of the raw data, kinds of the intermediate statistical value are “number of pieces”, “total value”, and “sum of squares” of the raw data. Furthermore, for example, in the case where the hind of the statistical value is “difference value” of raw data, kinds of the intermediate statistical value are “oldest time stamp and raw data corresponding to the time stamp” and “latest time stamp and raw data corresponding to the time stamp” of the raw data in a corresponding time range including the time stamps.

FIG. 6 is a schematic diagram illustrating an exemplary data structure of the second management information 27A. The second management information 27A is obtained by correlating an apparatus ID, a start time, a time range, a kind of a statistical value, a kind of an intermediate statistical value, and an intermediate statistical value to each other.

Note that at least one of time series data, a statistical value, and an intermediate statistical value may be stored in the second storage unit 27 as the first information. Therefore, at least one of the time series data and the statistical value may be registered in the second management information 27A instead of the intermediate statistical value or together with the intermediate statistical value.

Additionally, as described above, the first information includes at least one of the time series data, statistical value, and intermediate statistical value. Then, the statistical value is registered in the third storage unit 26. Therefore, the first information registered in the third storage unit 26 is the statistical value. Furthermore, the first information registered in the second storage unit 27 is at least one of the time series data, statistical value, and intermediate statistical value.

In the present embodiment, a description will be provided for au exemplary case where the intermediate statistical value is registered in the second storage unit 27 as the first information.

Returning to FIG. 2, the description will be continued. The information processing unit 20 controls the information processing device 10. The information processing unit 20 includes a communication unit 20A, a registration unit 20B, a registration frequency management unit 20C, an acquisition unit 20D, and an acquisition frequency management unit 20E. The communication unit 20A includes a time series data receiving unit 20F, an acquisition request receiving unit 20G, and a statistical value transmitting unit 20H.

The communication unit 20A, registration unit 20B, registration, frequency management unit 20C, acquisition unit 20D, acquisition frequency management unit 20E, time series data receiving unit 20F, acquisition request receiving unit 20G, and statistical value transmitting unit 20H are implemented by, for example, one or a plurality of processors. For example, each of the above units may be implemented by causing a processor such as a central processing unit (CPU) to execute a program, namely, software. Each of the above units may also be implemented by a processor such as a dedicated integrated circuit (IC), namely, hardware. Each of the above units may also be implemented by using software and hardware in combination. In the case of using a plurality of processors, each of the processors may implement one of the respective units or may implement two or more of the respective units.

Note that the term “processor” used in the present embodiment represents, for example, circuits such as a CPU, a graphical processing unit (GPU), an application specific integrated circuit (ASIC), a programmable logic device (such as simple programmable logic device (SPLDs)), a complex programmable logic device (CPLD), and a field programmable gate array (FPGA).

The processor reads and executes a program stored in the nonvolatile storage device 22, thereby implementing each of the above-described units. Note that a program may also be directly incorporated inside a circuit of the processor instead of storing the program in the nonvolatile storage device 22. In this case, the processor reads and executes the program incorporated inside the circuit, thereby implementing each of the above-described units.

The communication unit 20A communicates with external devices such as the apparatus 12 and the client device 14. The communication unit 20A includes the time series data receiving unit 20F, acquisition request receiving unit 20G, and statistical value transmitting unit 20H. The acquisition request receiving unit 20G and the statistical value transmitting unit 20H will be described later.

The time series data receiving unit 20F receives the time series data from the apparatus 12. As described above, for example, the time series data receiving unit 20F receives an HTTP POST request including the time series data. Every time the time series data is received, the time series data receiving unit 20F outputs the received time series data to the registration unit 20B.

The registration unit 203 registers the received time series data in the first storage unit 25. In the present embodiment, every time the time series data receiving unit 20F receives the time series data from the apparatus 12, the registration unit 20B sequentially registers the time series data in the first storage unit 25. Specifically, the registration unit 20B registers the time series data in the first management information 25A.

Every time the registration unit 20B registers the time series data in the first management information 25A, the registration unit 20B updates a registration frequency managed by the registration frequency management unit 20C.

The registration frequency management unit 20C manages the registration frequency. The registration frequency indicates a frequency to register time series data in the first storage unit 25. Specifically, the registration frequency indicates the number of pieces of time series data registered in the first storage unit 25 during a predetermined period.

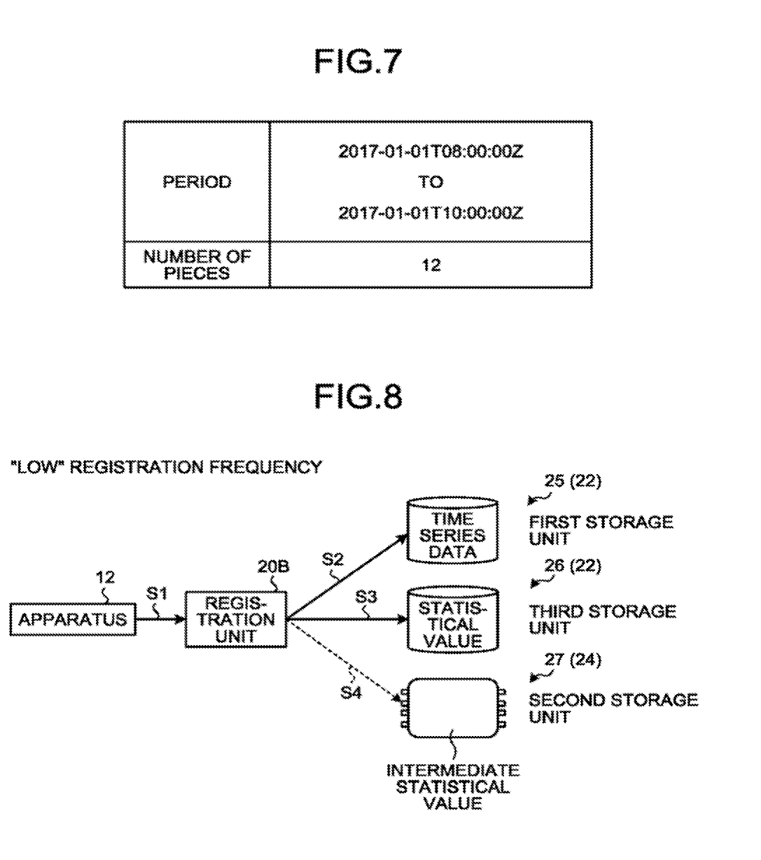

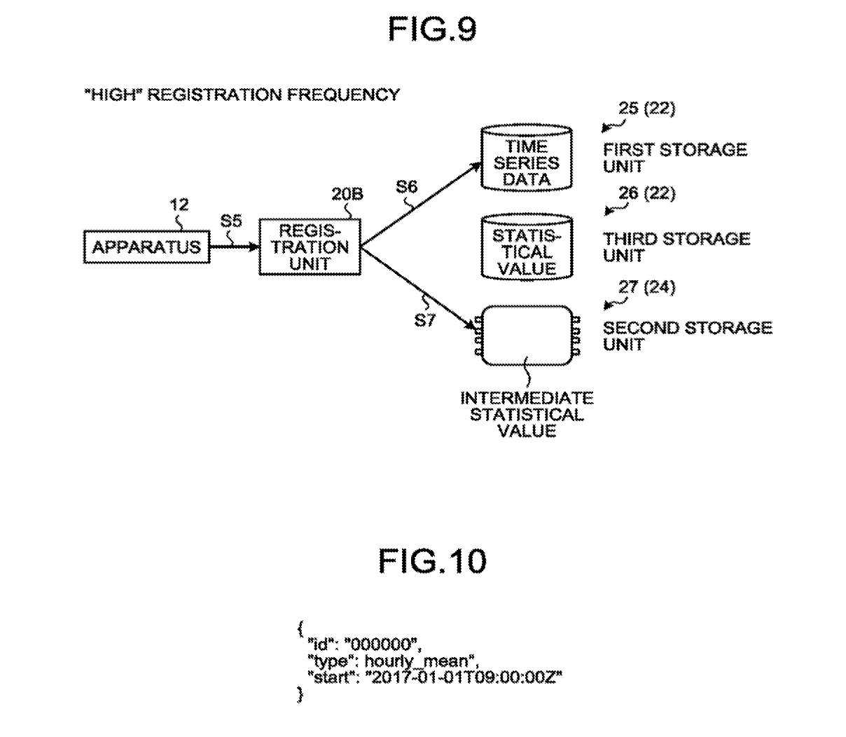

FIG. 7 is a schematic diagram illustrating an exemplary registration frequency. The registration frequency indicates the number of pieces of time series data registered in the first storage unit 25 during the predetermined period. The predetermined period may be predetermined. FIG. 7 illustrates a case where the predetermined period is set to two hours, for example.

Meanwhile, in the present embodiment, the registration unit 20B registers the time series data in the first storage unit 25 every time the time series data is received from the apparatus 12. Therefore, in the present embodiment, a description will be provided for an exemplary case where the information processing device 10 uses receiving frequency to receive the time series data from the apparatus 12 as the registration frequency. Meanwhile, the registration unit 20B may also regularly or irregularly register the time series data in the first storage unit 25 regardless of the receiving frequency of the time series data received from the apparatus 12. Therefore, the registration frequency is not limited to a mode conforming to the receiving frequency of the time series data from the apparatus 12.

Returning to FIG. 2, the description will be continued. The registration unit 20B updates the registration frequency every time the time series data received from the apparatus 12 is registered in the first storage unit 25. Note that it is assumed that a unit period (i.e., the above-described predetermined period) used to calculate the registration frequency is predetermined. Then, the registration unit 20B updates the registration frequency managed by the registration frequency management unit 20C such that the registration frequency becomes a value indicating the number of pieces of time series data (i.e., registration frequency) registered in the first storage unit 25 during a period from a time before the elapse of the unit period to a current time.

Meanwhile, the registration unit 20B may reset the registration frequency managed by the registration frequency management unit 20C to “0” and may newly start count of the registration frequency every time the above-mentioned unit period elapses. Additionally, the registration unit 20B may update the registration frequency managed by the registration frequency management unit 20C along the elapse of time so as to indicate latest registration frequency during the period from the time before the elapse of the unit period to the current time.

The registration unit 20B registers first information in the second storage unit 27 that is the volatile storage device 24 or in the third storage unit 26 that is the nonvolatile storage device 22 in accordance with the registration frequency of the time aeries data in the first storage unit 25. In other words, the registration unit 20B switches, in accordance with the registration frequency, a registration destination of the first information between the third storage unit 26 that is the nonvolatile storage device and the second storage unit 27 that is the volatile storage device.

Specifically, in the case where the registration frequency is less than a first threshold, the registration unit 20B registers the first information in the third storage unit 26. On the other hand, in the case where the registration frequency is the first threshold or more, the registration unit 20B registers the first information in the second storage unit 27.

The first threshold may be predetermined. For example, an upper limit of the registration frequency that satisfies a specific requirement (for example, a response period is one second or less) is obtained by experimentally measuring values of the response period or the like of the third storage unit 26 with respect to various values of the registration frequency, and the acquired upper limit may be predetermined as the first threshold.

Note that a fact that the registration frequency is less than the first threshold may be expressed as that the registration frequency is low in the following description. Furthermore, a fact that the registration frequency is the first threshold or more may be expressed as that the registration frequency is high in the following description.

In the case of determining that the registration frequency is low, the registration unit 20B registers the first information in the third storage unit 26.

FIG. 8 is a schematic diagram illustrating an exemplary flow of registration processing in the case of determining that the registration frequency is low. Upon receipt of time series data from the apparatus 12 (step S1), the registration unit 20B registers the time series data in the first storage unit 25 that is the nonvolatile storage device 22 (step S2). Then, in the case of determining that the registration frequency of the time series data in the first storage unit 25 is low, the registration unit 20B registers the first information in the third storage unit 26 (step S3).

As described above, a statistical value is registered as the first information in the third storage unit 26 in the present embodiment.

Therefore, in the case of determining that the registration frequency is low, the registration unit 20B acquires time series data from the first storage unit 25, calculates a statistical value, and then registers the same in the third storage unit 26 (also see FIG. 5).

At this point, the registration unit 20B may calculate a plurality of kinds of statistical values for each of time ranges different from each other, and register the same in the third storage unit 26. Also, the registration unit 20B may calculate a statistical value per apparatus 12 identified by an apparatus ID. Additionally, the registration unit 20B may calculate an intermediate statistical value based on the time series data registered in the first storage unit 25 regardless of from which apparatus 12 the time series data is received.

In the present embodiment, a description will provided for a case where the registration unit 20B calculates, per apparatus 12 identified by an apparatus ID, a statistical value indicating a kind of a statistical value “average value” for a predetermined time range (e.g., one hour) relative to each of different start times. Then, the registration unit 20B registers each of the calculated statistical values in the third management information 26A of the third storage unit 26 in association with the corresponding apparatus ID and start time (see FIG. 5).

In the case where the registration frequency is low, the registration unit 20B may store the first information in both the third storage unit 26 and the second storage unit 27.

In other words, in the case of determining the registration frequency of the time series data in the first storage unit 25 is low, the registration unit 20B may register the first information in the second storage unit 27 (Step S4) after registering the first information in the third storage unit 26 (step S3). Note that the registration unit 20B may also register the first information in the third storage unit 25 (step S3) after registering the first information in the second storage unit 27 (step S4).

Next, a case where the registration frequency is high will be described. In the case of determining that the registration frequency is high, the registration unit 20B registers the first information in the second storage unit 27.

FIG. 3 is a schematic diagram illustrating an exemplary flow of the registration processing in the case of determining that the registration frequency is high. Upon receipt of time series data from the apparatus 12 (step S5), the registration unit 208 registers the time series data in the first storage unit 25 that is the nonvolatile storage device 22 (step S6). Additionally, in the case of determining that registration frequency of the time series data in the first storage unit 25 is high, the registration unit 20B registers the first information in the second storage unit 27 that is the volatile storage device 24 (step S7).

As described above, at least one of time series data, a statistical value, and an intermediate statistical value is registered as the first information in the second storage unit 27. Additionally, in the present embodiment, a description will be provided for an exemplary case where the registration unit 20B registers an intermediate statistical value in the second storage unit 27 as the first information.

Therefore, in the case of determining that the registration frequency is high, the registration unit 20B acquires time series data from the first storage unit 25, calculates an intermediate statistical value, and registers the same in the second storage unit 27 (also see FIG. 6).

At this point, the registration unit 20B may calculate each of a plurality of hinds of intermediate statistical values corresponding to each of a plurality of kinds of statistical values for each of time ranges different from each other, and register the same in the second storage unit 27. Also, the registration unit 20B may calculate an intermediate statistical value per apparatus 12 identified by an apparatus ID. Additionally, the registration unit 20B may calculate an intermediate statistical value based on the time series data registered in the first storage unit 25 regardless of from which apparatus 12 the time series data is received.

In the present embodiment, a description will be provided for a case where the registration unit 20B calculates, per apparatus 12 identified by an apparatus ID, intermediate statistical values respectively indicating kinds of the intermediate statistical values “number of pieces of data” and “total value” corresponding to the kind of the statistical value “average value” for a predetermined time range (e.g., one hour) relative to each of different start times. Meanwhile, the time range used to calculate the intermediate statistical values is equal to the time range, or the time range or shorter than that used to calculate the statistical value stored in the third storage unit 26. Then, the registration unit 20B registers the calculated intermediate statistical values in the second management information 27A of the second storage unit 27 in association with the corresponding apparatus ID and start times.

Note that it is assumed that a difference value per hour is used as the statistical value. In this case, the registration unit 20B calculates, as intermediate statistical values, raw data corresponding to an oldest time stamp and raw data corresponding to a latest time stamp corresponding to a period within one hour, namely, the time range (e.g., range of one hour from 2017-01-01T09:00:00Z). Then, the registration unit 20B registers the calculated intermediate statistical values in the second management information 27A of the second storage unit 22 in association with the corresponding apparatus ID and start times. Furthermore, the registration unit 20B may suitably update these values with the elapse of time.

As described above, in the information processing device 10 of the present embodiment, in the case where the registration frequency is low, the first information (statistical value) is registered in the third storage unit 26. On the other hand, in the case where the registration frequency is high, the first information (e.g., intermediate statistical value) is registered in the second storage unit 27.

Therefore, in the present embodiment, in the case where the registration frequency is low, the registration unit 20B stores the first information more preferentially in the nonvolatile storage device 22 (third storage unit 26) than in the second storage unit 27, in which the nonvolatile storage device 22 is a memory having higher reliability. Additionally, in the present embodiment, in the case where the registration frequency is high, the registration unit 20B registers the first information more preferentially in the volatile storage device 24 (second storage unit 27) than in the third storage unit 26, in which the volatile storage device 24 has a high data registration speed and a less processing load.

Therefore, in the information processing device 10, suppression of degradation of reliability and reduction of the processing load can be achieved at the time of data registration.

Returning to FIG. 2, the description will be continued. The acquisition request receiving unit 20G receives an acquisition request from the client device 14. As described above, the acquisition request is an acquisition request for a statistical value.

The acquisition request includes, for example, an apparatus ID of an apparatus 12 from which a statistical value is to be acquired, a kind of the statistical value, a start time, and a time range. Meanwhile, in the case where the kind of the statistical value and the time range are predetermined between the information processing device 10 and the client device 14, the acquisition request may not necessarily include at least one of the kind of the statistical value and the time range. Additionally, there may be a case where a user operating the client device 14 wishes to acquire a statistical value regardless of from which apparatus 12 the time series data is received. In this case, the acquisition request may not necessarily include the apparatus ID.

For example, the information processing device 10 discloses an HTTP API to the user application 14A of the client device 14 and receives an acquisition request.

FIG. 10 is a diagram illustrating an exemplary data structure of an acquisition request. For example, the user application 14A of the client device 14 generates an HTTP POST request and transmits the same to the information processing device 10. The HTTP POST request includes, in a payload, the acquisition request having the data structure illustrated in FIG. 10, for example. In FIG. 10, “id” indicates an apparatus ID. “type” indicates a kind of a statistical value and a time range. The example illustrated in FIG. 10 illustrates “hourly_mean” that indicates the kind of the statistical value “average value” and the time range “one hour”. In FIG. 10, “start” indicates a start time.

Therefore, the acquisition request illustrated in FIG. 10 is the acquisition request, for “average value of raw data having a time stamp during the time range “one hour”, namely, from 9 to 10 o'clock with the start time of “9 o'clock on Jan. 1, 2017” with respect to an apparatus 12 identified by an apparatus ID “000000”.

Returning to FIG. 2, the description will be continued. Upon receipt of the acquisition request from the client device 14, the acquisition request receiving unit 20G outputs the same to the acquisition unit 20D.

Upon receipt of the acquisition request from the client device 14, the acquisition unit 20D acquires the first information from the third storage unit 26 or the second storage unit 27 in accordance with acquisition frequency.

The acquisition frequency is a frequency in which the acquisition unit 20D acquires information from the first storage unit 25, third storage unit 26, and second storage unit 27. This information is at least one of time series data, as statistical value, and an intermediate statistical value.

In the present embodiment, every time the acquisition unit 20D receives (acquires) an acquisition request from the client device 14, the acquisition unit 20D acquires information from the first storage unit 25, third storage unit 26, or second storage unit 27, and performs processing described later. Therefore, in the present embodiment, a description will be provided for an exemplary case where the acquisition unit 20D uses a frequency to receive an acquisition request from the client device 14 as the acquisition frequency. Meanwhile, the acquisition unit 20D may regularly or irregularly acquire information from the first storage unit 25, third storage unit 26, or second storage unit 27 regardless of the acquisition frequency to receive an acquisition request from the client device 14. Therefore, the acquisition frequency is not limited to a mode conforming to the frequency to receive an acquisition request from the client device 14.

In the present embodiment, every time the acquisition unit 20D receives an acquisition request from the client device 14 via the acquisition request receiving unit 20G, the acquisition unit 20D updates the acquisition frequency managed by the acquisition frequency management unit 20E.

The acquisition frequency management unit 20E manages the acquisition frequency. Specifically, the acquisition frequency indicates the number of acquisition requests acquired during a predetermined period. A data structure of the acquisition frequency is similar to the data structure of registration frequency (see FIG. 7).

Every time an acquisition request is received from the client device 14, the acquisition unit 20D updates the acquisition frequency. Note that a unit period used to calculate the acquisition frequency is predetermined. Furthermore, the acquisition unit 20D updates the acquisition frequency managed by the acquisition frequency management unit 20E so as to indicate the number of acquisition requests (i.e., acquisition frequency) acquired during a period from a time before the elapse of the unit period to a current time. For example, the acquisition unit 20D registers, in the acquisition frequency management unit 20E, the number of times of acquisition requests received during latest two hours (unit period) as the acquisition frequency.

Then, the acquisition unit 20D acquires the first information from the second storage unit 27 or third storage unit 26 in accordance with the acquisition frequency. In other words, the acquisition unit 20D switches an acquisition destination of the first information between the second storage unit 27 that is the volatile storage device 24 and the third storage unit 26 that is the nonvolatile storage device 22 in accordance with the acquisition frequency.

Specifically, in the case where the acquisition frequency is less than a second threshold, the acquisition unit 20D acquires the first information from the third storage unit 26. On the other hand, in the case where the acquisition frequency is the second threshold or more, the acquisition unit 20D acquires the first information from the second storage unit 27.

The second threshold may be predetermined. For example, an upper limit of the acquisition frequency that satisfies a specific requirement (for example, a response period is one second or less) is obtained by experimentally measuring values of the response period or the like of the third storage unit 26 with respect to various values of the acquisition frequency, and the acquired upper limit may be predetermined as the second threshold.

Note that a fact that the acquisition frequency is less than the second threshold may be expressed as that the acquisition frequency is low in the following description. Furthermore, a fact that the acquisition frequency is the second threshold or more may be expressed as that the acquisition frequency is high in the following description.

In the case of determining that the acquisition frequency is low, the acquisition unit 20B acquires the first information from third storage unit 26.

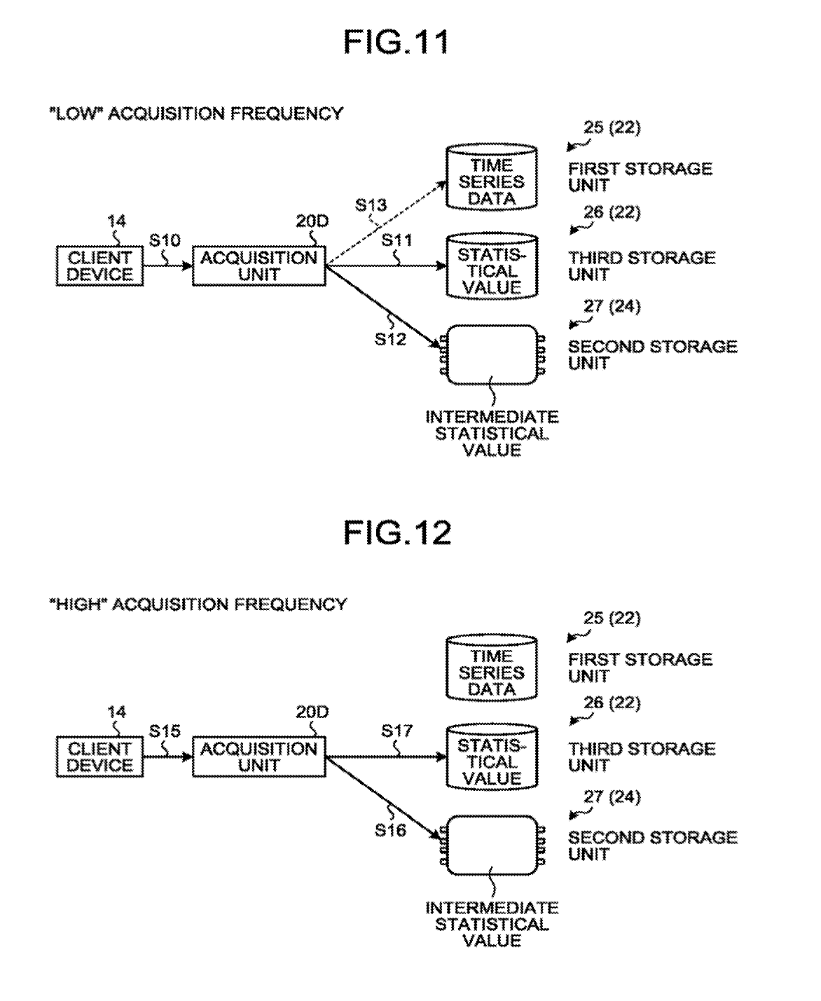

FIG. 11 is a schematic diagram illustrating art exemplary flow of acquisition processing in the case of determining that the acquisition frequency is low. Upon receipt of an acquisition request, from the client device 14, the acquisition unit 20D updates the acquisition frequency (step S10). Then, in the case of determining that the acquisition frequency is low, the acquisition unit 20D acquires the first information from the third storage unit 26 (step S11).

The acquisition unit 20D acquires the first information in response to the acquisition request received immediately before, Specifically, the acquisition unit 20D acquires, from the third storage unit 26, the first information corresponding to an apparatus ID, a kind of a statistical value, a start time, and a time range included in the acquisition request.

As described above, the statistical value is registered as the first information, in the third storage unit 26. Therefore, in the case of determining that the acquisition frequency is low, the acquisition unit 20D acquires the statistical value from the third storage unit 26.

Meanwhile, there may be a case where the first information (statistical value) in response to the acquisition request is not registered in the third storage unit 26 depending on a registration state by the registration unit 20B. In this case (in other words, in the case where the acquisition frequency is low and the first information is not registered in the third storage unit 26), the acquisition unit 20D may acquire the first information from the second storage unit 27 (Step S12).

Meanwhile, in the case where the acquisition frequency is low and the first information is not registered in the third storage unit 26, the acquisition unit 20D may acquire time series data from the first storage unit 25 (step S13). Also, in the case where the acquisition frequency is low and the first information is not registered in both the third storage unit 26 and the second storage unit 27, the acquisition unit 20D may acquire the time series data from the first storage unit 25.

As described above, in the present embodiment, the statistical value is registered as the first information in the third storage unit 26. Additionally, the intermediate statistical value is registered in the second storage unit 27. Furthermore, the time series data is registered its the first storage unit 25.

Therefore, when the acquired first information is the time series data or the intermediate statistical value, the acquisition unit 200 uses the time series data or the intermediate statistical value to calculate a statistical value in response to the acquisition request, acquired immediately before. The acquisition unit 20D may acquire the statistical value in response to the acquisition request through this calculation processing.

On the other hand, in the case of determining that the acquisition frequency is high, the acquisition unit 20D acquires the first information from the second storage unit 27. The acquisition unit 20D acquires the first information in response to the acquisition request in the same manner as described above.

Meanwhile, as described above, at least one of time series data, a statistical value, and an intermediate statistical value is registered, as the first information in the second storage unit 27. Therefore, there may be a case where a statistical value is not registered and time series data or an intermediate statistical value is registered in the second storage unit 27. In this case, the acquisition unit 20D uses the time series data or the intermediate statistical value to calculate a statistical value in response to sirs acquisition request. The acquisition unit 20D may acquire as statistical value in response to the acquisition request through this calculation processing.

FIG. 12 is a schematic diagram illustrating an exemplary flow of the acquisition processing in the case of determining that the acquisition frequency is high. Upon receipt of an acquisition request, from the client device 14 (step S15), the acquisition unit 20D updates acquisition frequency. Then, in the case of determining that the acquisition frequency is high, the acquisition unit 20D acquires first information from the second storage unit 27 (step S16).

As described above, an intermediate statistical value is registered in the second storage unit 27 in the present embodiment. Therefore, the acquisition unit 20D acquires the intermediate statistical value from the second storage unit 27. Then, the acquisition unit 20D uses the acquired intermediate statistical value to calculate a statistical value in response to the acquisition request. Consequently, the acquisition unit 20D acquires the statistical value.

Here, there may be a case where the first information (intermediate statistical value) in response to the acquisition request is not registered in the second storage unit 27 depending on a registration state by the registration unit 20B. In this case (in other words, in the case where the acquisition frequency is high and the first information is not registered in the second storage unit 27), the acquisition unit 20D may acquire the first information from the third storage unit 26 (Step S17).

Thus, in the present embodiment, in the case where the acquisition frequency is low, the acquisition unit 20D acquires the first information more preferentially from the nonvolatile storage device 22 (third storage unit 26) than from the second storage unit 27, in which the nonvolatile storage device 22 is the memory having higher reliability. Additionally, in the present embodiment, in the case where the acquisition frequency is high, the acquisition unit 20D acquires the first information more preferentially from the volatile storage device 24 (second storage unit 27) than from the third storage unit 26, in which the volatile storage device 24 has a high data acquisition speed and a less processing load.

Therefore, in the information processing device 10, suppression of degradation of reliability and reduction of the processing load can be achieved at the time of data acquisition.

Meanwhile, in the where the acquired first information is time series data or an intermediate statistical value, the acquisition unit 20D calculates a statistical value in response to the acquisition request. Consequently, the acquisition unit 20D acquires the statistical value in response to the acquisition request.

Meanwhile, since the intermediate statistical value is used as the first information, the acquisition unit 20D can reduce a calculation load for a statistical value more than in the case of calculating a statistical value from the time series data.

The acquisition unit 20D outputs the statistical value to the statistical value transmitting unit 20H. The statistical value transmitting unit 20H transmits the statistical value received from the acquisition unit 20D to the client device 14 that is the transmission source of the acquisition request.

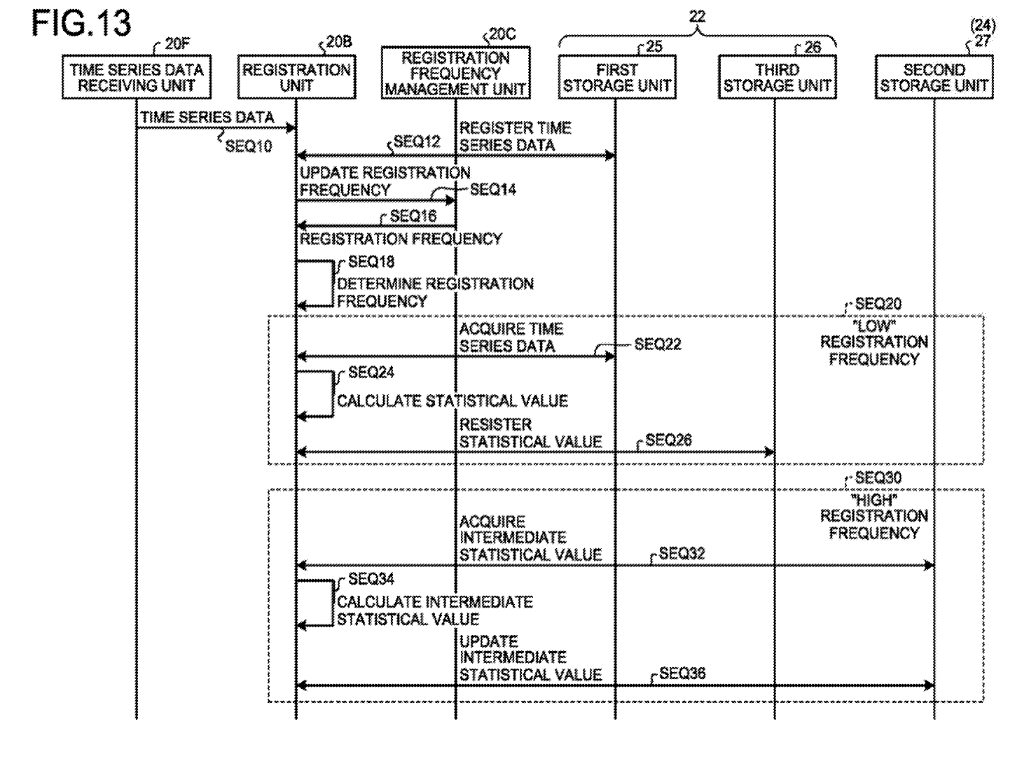

Next, a flow of information processing executed by the information processing device 10 of the present embodiment will be described. FIG. 13 is a sequence diagram illustrating an exemplary procedure of the registration processing executed by the information processing unit 20.

First, the time series data receiving unit 20F receives time series data from the apparatus 12. The apparatus 12 outputs the received time series data to the registration unit 20B (SEQ10).

The registration unit 20B registers the time series data in the first management information 25A of the first storage unit 25 (SEQ12).

Next, the registration unit 20B updates the registration frequency registered in the registration frequency management unit 20C (SEQ14). For example, the registration unit 20B reads a time stamp included in the time series data registered in the first storage unit 25 in SEQ12 and updates the registration frequency stored in the registration frequency management unit 20C. Specifically, the registration unit 20B updates the registration frequency by counting up the number of pieces of data indicated in the registration frequency by “1.”. Then, the registration unit 20B registers the updated registration frequency in the registration frequency management unit 20C. Consequently, the registration unit 20B updates the registration frequency registered in the registration frequency management unit 20C.

Next, the latest (updated) registration frequency is acquired from the registration frequency management unit 20C (SEQ16), determination is made on whether the registration frequency is the first threshold or more or less than the first threshold (SEQ18).

In the case of determining that the registration frequency is low (less than the first threshold), the registration unit 20B executes the processing illustrated in SEQ20. The processing illustrated in SEQ20 includes processing from SEQ22 to SEQ26.

First, the registration unit 20B acquires time series data from the first storage unit 25 (SEQ22).

For example, the registration unit 20B sets, as a start time, first timing in a time range including time stamps included in the time series data of SEQ10. Then, based on this start time, the registration unit 20B reads, from the first management information 25A of the first storage unit 25, raw data corresponding to the time stamp included in the time range and to be used to calculate a statistical value. The time range may be predetermined. Also, the time range may be one kind or a plurality of kinds.

For example, it is assumed that a time stamp included in the time series data acquired in SEQ10 is “9 o'clock 50 minutes 0 seconds on Jan. 1, 2017”, In this case, the registration unit 20B acquires raw data correlated to the time stamp in the time range of one hour (specifically, from 9 to 10 o'clock on Jan. 1, 2017) in which first timing of “9 o'clock: 0 minutes 0 seconds on Jan. 1, 2017” in the time range including the time stamp is set as the start time.

Then, the registration unit 20B uses the acquired time series data to calculate a statistical value (SEQ24). For example, the registration unit 208 uses raw data corresponding to each of acquired time stamps and calculates a statistical value having a predetermined kind of the statistical value (such as average values with respect to the raw data of the time range (e.g., one hour) from the start time.

Specifically, it is assumed that the registration unit 20B uses the time series data illustrated in FIG. 4 and calculates, as the statistical value, the kind of the statistical value “average value” relative to the time range of one hour in which the time stamp “9 o'clock 0 minutes 0 seconds on Jan. 1, 2017” is set as the start time. In this case, the registration unit 20B divides, by the number of pieces of the raw data, a total value of the raw data corresponding to the time stamps included in the time range having the above-described start time ((100+110+100+90+100+100)÷6−100). Then, the registration unit 20B registers, in the third management information 26A of the third storage unit 26, the statistical value (here, average value) obtained by this division as a statistical value corresponding to the start time “9 o'clock 0 minutes 0 seconds on Jan. 1, 2017” (see FIG. 5, SEQ26).

On the other hand, in the case of determining that the registration frequency is high (first threshold or more), the registration unit 20B executes processing illustrated in SEQ30. The processing illustrated in SEQ30 includes the processing from SEQ32 to SEQ3S.

First, the registration unit 20B acquires an intermediate statistical value corresponding to the start time from the second storage unit 27 (SEQ32). At this point, it is assumed that the intermediate statistical value stored in the second storage unit 27 is not latest data.

For example, the registration unit 20B first sets, as a start time, first timing in the time range including time stamps included in the time series data of SEQ10. Then, the registration unit 20B acquires an intermediate statistical value corresponding to the start time from the second storage unit 27 (SEQ32). For example, it is assumed that, the registration unit 20B acquires, from the second storage unit 27, intermediate statistical values “number of pieces of data; 9, total value: 900” corresponding to the start time “9 o'clock 0 minutes 0 seconds on Jan. 1, 2017”.

For example, the registration unit 20B acquires the above intermediate statistical values by requesting the second storage unit 27 to read the intermediate statistical values having keys of “count_2017-01-01T09:00:00Z” and “sum_2017-01-01T09:00: 00Z”.

Next, the registration unit 20B calculates the intermediate statistical values (SEQ34). In other words, the registration unit 20B updates the intermediate statistical values with latest values.

For example, the registration unit 20B counts up the number of pieces of data by “1” in the intermediate statistical values “number of pieces of data: 9, total value: 900” acquired in SEQ32 and updates the intermediate statistical value with “10”. Additionally, the registration unit 20B adds a value “100” of the raw data included in the time series data acquired in SEQ10 to the intermediate statistical value “sum total value: 900” acquired in SEQ32, and updates the intermediate statistical value with “1000”. Consequently, the registration unit 208 calculates the latest-intermediate statistical values.

Then, the registration unit 20B registers the intermediate statistical values calculated in SEQ34 in the second management information 27A of the second storage unit 27. Consequently, the registration unit 20B updates the intermediate statistical values (SEQ36).

Specifically, for example, the registration unit 20B registers, as the intermediate statistical values corresponding the start time “3 o'clock 0 minutes 0 seconds on Jan. 1, 2017”, the calculated intermediate statistical values “the number of pieces of data: 10, the total value: 1000” in the second management information 27A of the second storage unit 27.

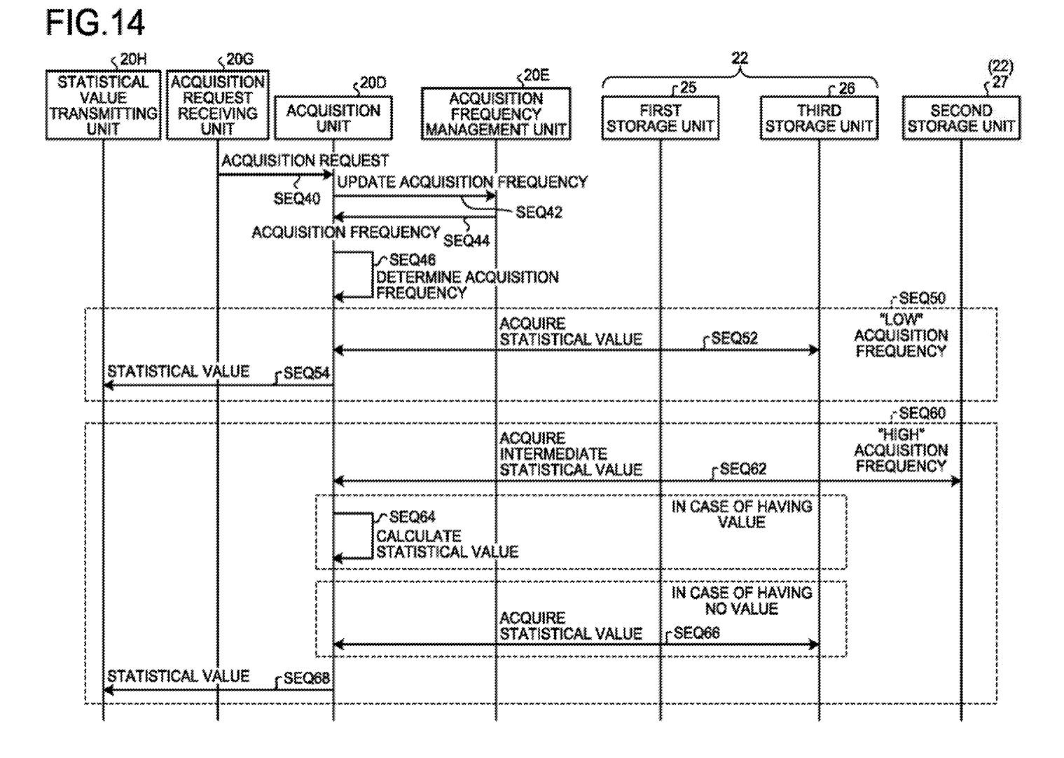

Next, the acquisition processing executed by the information processing device 10 of the present embodiment, will be described. FIG. 14 is a sequence diagram illustrating an exemplary procedure of the acquisition processing executed by the information processing unit 20.

First, the acquisition request receiving unit 20G receives an acquisition request from the apparatus 12. For example, it is assumed that the acquisition request receiving unit 20G receives the acquisition request illustrated in FIG. 10. As described above, the acquisition request illustrated in FIG. 10 is the acquisition request for “average value of raw data having time stamps during the time range of “one hour”, namely, from 9 to 10 o'clock with the start time of “9 o'clock on Jan. 1, 2017” with respect to the apparatus 12 identified by the apparatus ID “000000”.

Then, the acquisition request receiving unit 20G outputs the received acquisition request to the acquisition unit 20D (SEQ40). Upon receipt of the acquisition request, the acquisition unit 20D updates the acquisition frequency managed by the acquisition frequency management unit 20E (SEQ42). For example, the acquisition unit 20D updates the acquisition frequency by using the time stamp indicating timing of acquiring the acquisition request in SEQ40.

Then, the acquisition unit 20D acquires latest acquisition frequency from the acquisition frequency management unit 20S (SEQ44). Next, the acquisition unit 20D determines whether the acquisition frequency acquired in SEQ44 is high (the second threshold or more) or low (less than the second threshold) (SEQ46).

In the case of determining that the acquisition frequency is low, the acquisition unit 20D executes processing of SEQ50. The processing of SEQ50 includes SEQ52 to SEQ54.

First, the acquisition unit 20D acquires, from the third storage unit 26, a statistical value in response to the acquisition request acquired in SEQ40 (SEQ52).

For example, the acquisition unit 20D acquires, from the third management information 26A of the third storage unit 26 (see FIG. 5), the statistical value “100” corresponding to the apparatus ID “000000”, the start time “9 o'clock on Jan. 1, 2017”, the time range “one hour”, and the kind of the statistical value “average value” included in the acquisition request acquired in SEQ40.

Then, the acquisition unit 20D transmits the statistical value acquired in SEQ52 to the client device 14 that is a transmission source of the acquisition request via the statistical value transmitting unit 20H (SEQ54).

On the other hand, in the case of determining that the acquisition frequency is high in SEQ46, the acquisition unit 20D executes processing of SEQ60. The processing of SEQ60 includes SEQ62 to SEQ68.

First, the acquisition unit 20D acquires, from the second storage unit 27, an intermediate statistical value in response to the acquisition request acquired in SEQ40 (SEQ62). For example, the acquisition unit 20D acquires, from the second management information 27A of the second storage unit 27, intermediate statistical values “number of pieces of data, “total value” correlated to the apparatus ID “000000”, start time “9 o'clock on Jan. 1, 2017”, time range “one hour”, kind of the statistical value “average value” included in the acquisition request acquired in SEQ40.

Then, in the case of acquiring the intermediate statistical values from the second management information 27A, the acquisition unit 20D uses the acquired intermediate statistical values to calculate a statistical value in response to the acquisition request acquired in SEQ40 (SEQ64). For example, the acquisition unit 200 uses the intermediate statistical values (“number of pieces of data: 10”, “total value: 1000”) to calculate a statistical value “100” indicating the average value. Then, the processing proceeds to SEQ68 described later.

On the other hand, there may he a case where the intermediate statistical value in response to the acquisition request acquired in SEQ40 is not registered in the second storage unit 27. In this case, the acquisition unit 20D acquires, from the third storage unit 26, the statistical value in response to the acquisition request acquired in SEQ40 (SEQ66).

For example, the acquisition unit 20D acquires, from the third management information 26A of the third storage unit 26 (see FIG. 5), the statistical value “100” corresponding to the apparatus ID “000000”, the start time “0 o'clock on Jan. 1, 2017”, the time range “one hour”, and the kind of the statistical value “average value” included in the acquisition request acquired in SEQ40. Then, the processing proceeds to SEQ68.

In SEQ68, the acquisition unit 20D transmits, via the statistical value transmitting unit 20H, the acquired statistical value to the client device 14 that is the transmission source of the acquisition request (SEQ68).

As described above, the information processing device 10 of the present embodiment includes the registration unit 20B. The registration unit 20B registers the first information in the second storage unit 27 or the third storage unit 26 in accordance with the registration frequency. The registration frequency is registration frequency of the time series data in the first storage unit 25. The first information is the information related to a statistical value of the time series data.

As described above, in the present embodiment, the information processing device 10 switches a registration destination of the first information related to the statistical value of the time series data between the third storage unit 26 that is the nonvolatile storage device 22 and the second storage unit 27 that is the volatile storage device 24 in accordance with the registration frequency. Therefore, the information processing device 10 of the present embodiment can achieve both suppression of degradation of data reliability and reduction of a processing load.

Therefore, the information processing device 10 of the present embodiment can suppress degradation of reliability and reduce the processing load.

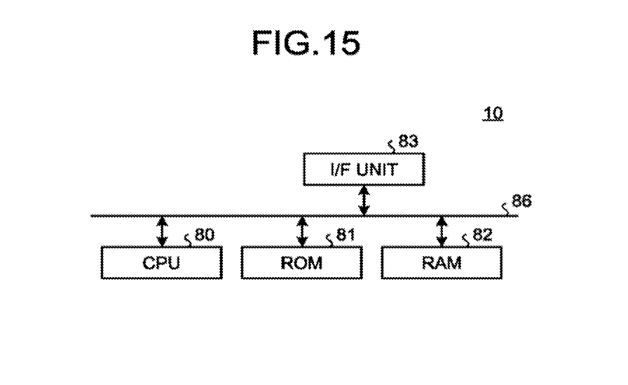

Next, an exemplary hardware configuration of the information processing device 10 of the above embodiment will be described. FIG. 15 is an exemplary hardware configuration diagram of the information processing device 10 of the above embodiment.

The information processing device 10 of the above embodiment includes a control device such as a CPU 80, a storage device such as a read only memory (ROM) 81 and a random access memory (RAM) 82, an I/F unit 83 that is an interface of various kinds of apparatuses, and a bus 86 to connect respective components, and has a hardware configuration utilizing a normal computer. The ROM 61 is an example of the nonvolatile storage device 22. The RAM 82 is an example of the volatile storage device 24.

In the information processing device 10 of the above embodiment, the CPU 80 reads a program from the ROM 81 onto the RAM 82 and executes the same, thereby implementing the above-described units on the computer.

Note that a program adapted to execute the respective processing and executed by the information processing device 10 of the above embodiment may be stored in the ROM 81. Furthermore, the program adapted to execute the respective processing and executed by the information processing device 10 of the above embodiment may also be provided by being incorporated in the ROM 81 in advance.

Additionally, the program adapted to execute the respective processing and executed by the information processing device 10 of the above embodiment may also be provided as a computer program product stored in a computer-readable storage medium such as a CD-ROM, a CD-R, a memory card, a digital versatile dish (DVD), or a flexible disk (FD) in a file having an installable format or executable format. Furthermore, the program adapted to execute the respective processing and executed by the information processing device 10 of the above embodiment may be provided by being stored on a computer connected to a network such as the Internet and being downloaded via the network. Additionally, the program adapted to execute the respective processing and executed by the information processing device 10 of the above embodiment may also be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fail within the scope and spirit of the inventions.

What is claimed is:

1. An information processing device comprising:
a memory; and
one or more processors configured to function as a registration unit, wherein
the registration unit configured to register first information related to a statistical value of time series data in a second storage unit that is a volatile storage device or in a third storage unit that is a nonvolatile storage device in accordance with a registration frequency of the time series data in a first storage unit.

2. The information processing device according to claim 1, wherein
in the case where the registration frequency is less than a first threshold, the registration unit registers the first information in the third storage, and
in the case where the registration frequency is the first threshold or more, the registration unit registers the first information in the second storage unit.

3. The information processing device according to claim 1, wherein
the first information includes at least one of the time series data, the statistical value, and an intermediate statistical value of the time series data and the statistical value,
the first information registered in the third storage unit is the statistical value, and
the first information registered in the second storage unit is at least one of the time series data, the statistical value, and the intermediate statistical value.

4. The information processing device according to claim 3, wherein the one or more processors are further configured to function as an acquisition unit, and
the acquisition unit acquires the first information from the second storage unit or the third storage unit in accordance with acquisition frequency of information from the first storage unit, the second storage unit, and the third storage unit.

5. The information processing device according to claim 4, wherein
in the case where the acquisition frequency is less than a second threshold, the acquisition unit acquires the first information from the third storage unit, and
in the case where the acquisition frequency is the second threshold or more, the acquisition unit acquires the first information from the second storage unit.

6. The information processing device according to claim 5, wherein
in the case where the acquisition frequency is less than the second threshold and the first information is not registered in the third steerage unit, the acquisition unit acquires the time series data or the first information from the first storage unit or the second storage unit.

7. The information processing device according to claim 5, wherein
in the case where the acquisition frequency is the second threshold or more and the first information is not stored in the second storage unit, the acquisition unit acquires the first information from the third storage unit.

8. The information processing device according to claim 4, wherein
in the case where the acquired first information is the time series data or tine intermediate statistical value, the acquisition unit uses the time series data or the intermediate statistical value to calculate the statistical value in response to an acquisition request.

9. An information processing device comprising:
a memory; and
one or more processors configured to function as an acquisition unit, wherein
the acquisition unit acquires first information related to a statistical value of time series data from a second storage unit that is a volatile storage device or from a third storage unit that is a nonvolatile storage device in accordance with acquisition frequency of information.

10. An information processing system including an apparatus and an information processing device configured to communicate with the apparatus,
the information processing device comprising:
a memory; and
one or more processors configured to function as a registration unit, wherein
the registration unit registers first information related to a statistical value of time series data in a second storage unit that is a volatile storage device or in a third storage unit that is a nonvolatile storage device in accordance with registration frequency, in a first storage unit, of the time series data received from the apparatus.

11. A computer program product comprising a non-transitory computer program configured to cause a computer to execute
a step of registering first information related to a statistical value of time series data in a second storage unit that is a volatile storage device or in a third storage unit that is a nonvolatile storage device in accordance with registration frequency of the time series data in a first storage unit.
